(19) United States
(12) Patent Application Publication
(10) Pub. No.: US 2017/0197361 A1
(43) Pub. Date: Jul. 13, 2017

(54) System for Forming a Dimensionally Stable Object by Selective Solidification Section by Section of a Dimensionally Unstable Mass

(71) Applicant: Way to Production GmbH, Wien (AT)

(72) Inventor: Klaus STADLMANN, Traiskirchen (AT)

(73) Assignee: Way to Production GmbH, Wien (AT)

(21) Appl. No.: 15/326,181

(22) PCT Filed: Jul. 20, 2015
(86) PCT No.: PCT/EP2015/066521

§ 371 Date: Jan. 13, 2017

(30) Foreign Application Priority Data
Jul. 22, 2014 (AT) A580/2014

(51) Int. Cl. B29C 67/00; B33Y 30/00

(52) U.S. Cl. CPC B29C 67/0062; B33Y 30/00; B29K 2105/0058

(57) ABSTRACT

A system for forming one or a plurality of dimensionally stable objects by selective section-by-section solidification of a dimensionally unstable mass. The system includes a main body which is arranged so as to be stationary, a trough configured for connection to the main body to receive the mass, one or a plurality of controllable radiation source(s) to emit radiation which is suitable to solidify the mass, a base body on which the object to be formed may be constructed, a holding device to receive or hold the base body, a housing which surrounds at least the trough and the radiation source, and a moving device connected or coupled to the main body and the holding device. The moving device includes a drive, so that the holding device is capable of movement relative to the main body by activating the drive.

### CROSS-REFERENCE TO RELATED APPLICATIONS

The present application is a National Stage application of PCT International Application No. PCT/EP2015/066521 (filed on Jul. 20, 2015), under 35 U.S.C. §371, which claims priority to Austrian Patent Application No. A580/2014 (filed on Jul. 22, 2014), which are each hereby incorporated by reference in their respective entireties.

### TECHNICAL FIELD

The invention relates to a system for forming, in particular for forming in layers, one or a plurality of dimensionally stable objects by selective section by section solidification of a dimensionally unstable mass, such as in particular of a liquid, which can be hardened by light. The invention relates in particular also to a system and to a trough for layer by layer construction of a body, as it is described in Austrian patent applications AT50390/2013 and AT50391/2013, for example.

### BACKGROUND

According to prior art, so-called 3D printers are known. In the case of these devises, a powdery or liquid substance, for example, is hardened selectively by the impact of light or thermal radiation, so as to thus form a solid body layer by layer. In the case of these methods, which are known as stereolithography, for example, photo-sensitive synthetic resins or photopolymers are formed into a body by means of layer by layer selective hardening layer by layer. According to the prior art, the hardening takes place in a closed housing, so as to avoid the escape of intensive light radiation on the one hand and as so as to shield moved parts in response to the printing process on the other hand, so that the device and the operator are protected.

It is a disadvantage of common designs that the size of the body to be formed is limited by the free size in the interior of the housing. A further disadvantage of common 3D printers, in the case of which a liquid is hardened by means of light radiation, is that only a single body of a single liquid can be formed in one operating process.

### SUMMARY

It is now the object of the invention to create a device and/or a method, if applicable, for forming one or a plurality of dimensionally stable objects by selective section by section solidification of a dimensionally unstable mass, the flexibility of which is increased. On the one hand, the flexibility comprises that any three-dimensional bodies of almost any size can be formed or expanded. On the other hand, the flexibility also comprises that multi-part bodies or bodies of two or a plurality of different materials or masses can be formed.

If applicable, the invention also provides for a flexible printing or attaching of an object to a selectable base body, wherein a plurality of different masses can be used, if applicable, wherein a body or the constructed object can be accessed from the outside, if applicable, or is at least partially arranged outside of the housing, and wherein a sufficient shielding is preferably nonetheless at hand by means of the housing.

The object according to the invention is solved in particular by means of the features of the independent patent claims.

The invention relates in particular to a system for forming one or a plurality of dimensionally stable objects by selective section by section solidification of a dimensionally unstable mass, such as in particular a liquid, which can be hardened by light, comprising in particular a main body, which is in particular arranged so as to be stationary; a trough, which can be connected or which is connected to the main body, for receiving the mass; one or a plurality of controllable radiation source(s) for emitting a radiation, which is suitable to solidify the mass and which is in particular designed as light source; a main body, on which the object to be formed can be constructed or is constructed, a holding device for receiving or holding the main body; a housing, which surrounds the trough and preferably also the radiation source, if applicable; and/or a moving device, which is connected or coupled to the main body and to the holding device, wherein the moving device comprises a drive, so that the holding device is capable of being moved relative to the main body by activating the drive, wherein the housing is embodied in several parts, wherein a first housing part is connected to the main body and a second housing part is connected to the holding device, so that a relative movement between first housing part and second housing part is effected in response to the relative movement of the holding device relative to the main body, and/or wherein the main body, which is held or received in the holding device, extends outwards and/or can be accessed from the outside.

If applicable, provision is made for the trough to be open to the top, for the trough to have bottom, which is permeable for the radiation of the radiation source, in particular a light-permeable or transparent bottom, for the mass to be arranged or to be capable of being arranged in the trough, for the base body, which is held or arranged in the holding device, to be immersed into the mass from the top or is attached to the mass for forming one or a plurality of dimensionally stable objects, for the radiation source(s) to be arranged below the trough and to be directed through the bottom of the trough in the direction of the base body, or for the radiation of the radiation source(s) to be directed in the direction of the base body from below the trough and through the bottom of the trough, and/or for the mass, which is provided between the bottom of the trough and the base body for forming one or a plurality of dimensionally stable objects, to be capable of being solidified or is solidified by selective section by section radiation by means of the radiation source(s).

For the formation of the object or the objects, provision is made if applicable for the holding device to be capable of being brought from a first position into a second position by activating the moving device, wherein the distance of the holding device covered thereby corresponds approximately to the height of the object constructed in response to this movement.

If applicable, provision is made for the holding device to be capable of being brought from a first position into a second position by activating the moving device, and for the holding device to be capable of being brought into N intermediation positions, which are located between the first position and the second position, by activating the moving device, so that the formed object comprises a plurality of layers, which are connected to one another, in particular N+2 layers, which are connected to one another.

For the formation of the object or the objects, provision is made if applicable for the holding device and the second housing part to be capable of being brought from a first position into a second position, and, if applicable, into N intermediate positions by activating the moving device, wherein the distance of the holding device covered thereby corresponds approximately to the height of the constructed object, and for the first housing part and the second housing part to overlap in the first position by an overlap distance, wherein the overlap distance is larger than the distance covered by the holding device, so that the first housing part and the second housing part also overlap one another in the second position, wherein the housing parts preferably overlap one another along their entire circumference.

If applicable, provision is made for the housing to be embodied in a box-shaped manner, wherein the one housing part is embodied so as to be larger than the other housing part, so that the two housing parts can be inserted into one another and, together, surround or shield at least the trough and preferably also the radiation source in the first position and in the second position, and for the two housing parts, which are provided on the system, to preferably surround or shield, if applicable, at least the trough and preferably also the radiation source in every operating position, and overlap one another.

If applicable, provision is made for the base body to be an object carrier, to which the object is attached, for the main body itself to be an object, which is constructed from a mass, or for the base body to be a part of the object or a part of the product, which is made by the construction of an object.

If applicable, provision is made for the housing and in particular the second housing part to have a closable housing opening, wherein the housing opening is arranged in the area of the holding device or is formed by the holding device, and for the base body to protrude into the housing through the housing opening.

If applicable, provision is made for the housing and in particular the second housing part to have a closable housing opening, and for the housing opening to be capable of being closed or to be closed by the base body, so that in particular a substantially closed housing is formed.

If applicable, provision is made for the housing opening to be provided in the upper part of the second housing part and for the base body to protrude into the housing from the top.

If applicable, provision is made for the housing to be located on the outside and to in particular be accessible freely from the outside.

If applicable, provision is made for the first housing part and the main body to be connected to one another in one piece, or for the first housing part to be connected to the main body as independent body.

If applicable, provision is made for the base body to be arranged so as to be removable from the outside and to the outside, or for the base body to be connected or to be capable of being connected to the holding device so as to be removable from the outside and to the outside.

If applicable, provision is made for the moving device to comprise a guide device or a plurality of guide devices, via which the movement of the holding device and of the second housing part is guided relative to the main body and in particular guided in parallel.

If applicable, provision is made for the trough to comprise one or a plurality of separating web(s), so that two or a plurality of partial troughs, which are laterally separated from one another, are formed.

If applicable, provision is made for different masses to be arranged in at least two partial troughs, wherein the different masses differ from one another for example by different compositions, different colors, different fillers, different additives and/or different viscosity.

If applicable, provision is made for the or least one radiation source to be embodied as projector, such as in particular as DLP projector, as DMD projector or as LCD projector, as semiconductor-based light source, such as in particular as laser diode and/or as image representation surface, such as in particular as LED or OLED display.

If applicable, provision is made for the radiation source to be capable of being moved in a plane, which is parallel to the layer of the object, which is to be constructed, and to be capable of being displaced, in particular in a driven manner, so that a plurality of partial areas of the layer, which are arranged next to one another, can be solidified and connected to one another in succession.

If applicable, provision is made for a plurality of radiation sources to be provided and, if applicable, for one or a plurality of radiation sources to be capable of being moved in a plane, which is parallel to the layer of the object, which is to be constructed, and to be capable of being displaced, in particular in a driven manner.

If applicable, the invention relates to a system for forming one or a plurality of dimensionally stable objects by selective section by section solidification of a dimensionally unstable mass, such as in particular a liquid, which can be hardened by light, comprising a main body, which is in particular arranged so as to be stationary; a trough, which can be connected or which is connected to the main body, for receiving the mass; one or a plurality of controllable radiation source(s) for emitting a radiation, which is suitable to solidify the mass and which is in particular embodied as light source; a base body, on which the object to be formed can be constructed or is constructed, a holding device for receiving or holding the base body; a housing, which surrounds at least the trough and preferably also the radiation source, a moving device, which is connected or coupled to the main body and to the holding device, wherein the moving device comprises a drive, so that the holding device is capable of being moved relative to the main body by activating the drive, wherein the base body is a part of a die, and that the formed object forms at least a part of the die surface.

If applicable, provision is made for the base body to be a part of a die and for the formed object to form at least a part of the die surface.

If applicable, provision is made for the base body to be a part of a die, for the object to form at least a part of the die surface, for the die to comprise a die handle and a die surface, and for the formed die surface to comprise relief-like elevations and depression, the shape and course of which can be stamped onto a substrate by means of a stamping ink.

If applicable, provision is made for the die handle to be a part of the base body, or for the die handle and the die surface to be parts of the formed object, wherein the die surface and the die handle are or will preferably be made of different masses.

If applicable, provision is made for a handling device to be provided, which comprises at least one movable arm, for the arm of the handling device to be capable of being coupled or to be coupled to the base body, so that the base body can also be moved by moving the arm of the handling device.

If applicable, provision is made for the arm to have at least one, preferably two driven variances relative to the main body, so that the base body is capable of being moved relative to the holding device, wherein the movement is a rotational movement about a vertical axis, a translatory lifting movement for lifting the base body off the holding device, a translatory lowering movement for placing the base body onto the holding device and/or a pivoting movement for removing the base body from the holding device and the main body.

If applicable, provision is made for at least a part of the handling device to be rigidly connected to the main body, or for the handling device to be an independent module, which is positionally centered at least in parts relative to the main body, the base body or the holding device via one or a plurality of centering means.

If applicable, provision is made for a separating web to be provided in the trough, so that at least two partial troughs are formed by means of the separating web, or that provision is made in the trough for a plurality of separating webs, so that at least two or a plurality of partial troughs are formed by means of the separating webs.

If applicable, provision is made for a first mass to be provided in a first partial trough, for a second mass to be provided in a second partial trough, and for the first mass to be made of a material, the substances of which differ at least partially from the substances or the concentrations of the second mass.

If applicable, provision is made for the partial troughs to be separated from one another on the side by means of one or a plurality of separating webs, so that an independent mixing of a first mass, which is provided in the first partial trough, and of a second mass, which is provided in a second partial trough, is prevented.

If applicable, provision is made for the separating web or webs to be connected to the trough in one piece, or for the separating web or webs to be connected or will be connected to the trough in a positive manner or by means of a substance-to-substance bond.

If applicable, provision is made for the trough and the separating webs to be made of an elastic material, wherein the elastic material contains silicon, for example, and is in particular a silicon mixture.

If applicable, provision is made for connecting elements to be provided for connecting the trough to the main body.

If applicable, provision is made for the connecting elements to comprise exemptions, wherein these exemptions are in particular equipped and/or suitable to be connected to elements of the main body, wherein the elements of the main body, which engage with the connecting elements of the trough, are arranged so as to be movable, if applicable, so that a tensioning of the trough, a bending of the trough, a shifting of the trough and/or a relaxing of the trough can take place via movement of the elements of the main body.

If applicable, provision is made for the connecting elements to have magnetic or magnetizable elements, wherein these elements are in particular equipped to provide for a magnetic connection of the trough to the main body.

If applicable, provision is made for the exemptions to run into the side areas of the trough vertically from the bottom, wherein the side areas of the trough are in particular laterally projecting lugs.

If applicable, provision is made for the exemptions to have undercuts, which in particular run substantially horizontally into the trough material, so that a locking of the trough relative to the main body can take place via hook elements.

If applicable, provision is made for the second housing part to be connected to the holding device, so that the second housing part is a part of the holding device, and that the base body is held by and is capable of being moved by the second housing part.

If applicable, provision is made for the holding device to comprise a component, which is embodied in a frame-shaped manner, which has an exemption, through which the trough can preferably be guided horizontally and can be connected to the main body, for the second housing part to be held by the component, which is embodied in a frame-shaped manner, and to be moved or moves, if applicable, and for the base body to be held by the holding device and/or the housing.

If applicable, provision is made for the moving device to engage with the frame-shaped component.

The system according to the invention preferably comprises a plurality of components. The object according to the invention is solved by means of the synergetic interaction of two or a plurality of these components.

The system according to the invention preferably comprises a main body. The main body is in particular arranged so as to be stationary and can be placed or arranged on a fixed ground, for example, such as a bottom or a table. Operating elements can be provided on the main body. These operating elements comprise switches, for example, which are equipped to influence the function of the system according to the invention. These switches can in particular be on/off switches or functional switches for starting the formation of the object or for other functions. Provision can furthermore be made on the main body for a display device, such as in particular a graphic display. Information relating to the production process can be displayed on this display. For example, this display device can display information relating to the object, relating to the production progress or relating to further parameters. If applicable, the display device comprises a touch-sensitive display device, such as in particular a touch screen.

Further components, such as the trough, a moving device, a part of the housing, a radiation source, a handling device or further components can furthermore be provided on the main body or can be connected to the main body.

The system according to the invention preferably comprises a trough. This trough is equipped and/or suitable to receive the mass, from which the object, which is to be formed, is formed. The trough can in particular be embodied according to the Austrian patent applications AT50390/2013 and AT50391/2013. The trough preferably has a bottom, which is permeable for the radiation of the radiation source, so that radiation emanating from the radiation source can act on the mass located in the trough through the bottom of the trough. If applicable, the bottom of the trough is light-permeable. If applicable, the bottom of the trough is transparent. At least a part of the trough and in particular the bottom of the trough is preferably made of an elastic or deformable material, so that the bottom can be deformed by mechanical impact from further elements. The removability of the object from the bottom of the trough can be improved by means of this deformation.

If applicable, the side walls of the trough are also made of an elastic material. If applicable, the trough is made in one piece of an elastic, light-permeable or transparent material. The production costs of the trough can be lowered through this, for example. In the case of a trough, the bottom and side walls of which are embodied elastically, the dumping of the mass located in the trough can be made easier by bending the bottom and the trough. If applicable, a side wall in particular bends outwards in a beaked manner, when the bottom area of the trough is bent. An accurate dumping of the mass located in the trough can be made possible by means of the formation of the beaked bulge.

If applicable, the trough comprises one or a plurality of separating webs, so that two or a plurality of partial troughs are formed. For example, two partial troughs can be formed by means of a single separating web. For example, different masses can be arranged in the two partial troughs, which are separated from one another, so as to form objects of different masses. If applicable, a plurality of separating webs is present, so that a plurality of partial troughs, which are laterally separated from one another, is formed. Different masses or also the same mass can be or are capable of being arranged in the partial troughs.

The separating webs can be connected to the trough in one piece or can be a part of the trough, respectively. If applicable, the separating webs are webs, which are inserted subsequently. If applicable, the separating webs are webs, which are inserted subsequently, which are or will be connected to the trough in a positive manner or by means of a substance-to-substance bond, and which are in particular adhered or welded to the trough.

If applicable, the base body can be removed to the outside and from the outside in all embodiments. If applicable, the base body extends outwards in all embodiments. If applicable, the base body can be a part of the object or a part of the product, which is to be formed, in all embodiments.

According to a further embodiment of the system according to the invention, provision can be made in all embodiments for a heatable or heated installation space. If applicable, the interior of the housing, the mass, the base body, the inner space of the second housing part and further components of the system can be capable of being heated or can be heated in all embodiments. For example, radiators, in particular radiant heaters, IR radiators or inductive heating devices, etc., can in particular be provided as heating device. If applicable, the base body can also be heated or can be capable of being heated. If applicable, these radiators in the interior of the housing are directed to the mass and in particular onto the mass from below. If applicable, the radiators are directed onto the mass from above. If applicable, one radiator or a plurality of radiators is or are connected to the holding device, so that they can preferably be moved with the holding device. If applicable, however, the heating device is also a heating element, which emits heat to the housing interior via artificial or natural convection. By heating the mass, in particular the consistency thereof, for example the viscosity thereof, can be changed in order to optimize the construction process of the object. The tendency of the mass to adhere to the trough can in particular also be optimized.

If applicable, the trough is produced by means of an injection molding process. The trough and, if applicable, the separating elements as well as the partial troughs are in particular made as a single trough body, which is formed in particular by means of an injection molding process and/or embossing process. The trough is preferably made of an elastic material. In particular, this material is or contains silicon.

If applicable, the moving device is embodied in such a way that a substantially free accessibility of the trough from the outside is made possible when the second housing part is taken off. The elements of the moving device are in particular embodied in a rod-shaped and narrow manner, so that free surfaces are provided therebetween, whereby the handling of the elements of the device located on the inside is facilitated. The second housing part can thus be taken off during the construction of the object, for example, so as to monitor the construction progress, for example, or so as to refill a mass into the trough.

### DRAWINGS

The invention will be described in more detail below by means of the figures and by means of concrete exemplary embodiments.

FIGS. 1a, 1b and 1c show angular views of a system according to the invention from the outside in different positions.

FIG. 2 shows an angular view of the system according to the invention, wherein several components, in particular parts of the housing, are hidden.

FIGS. 3a, 3b and 3c show three different positions of the system according to the invention, wherein parts of the housing and of the main body as well as further components are hidden.

FIG. 4 shows a plurality of views of possible embodiments of a trough and of a base body.

FIG. 5 shows details of a trough.

FIG. 6 shows a possible embodiment of a base body and in particular of an object carrier.

FIG. 7 shows a plurality of views of a system according to the invention comprising a handling device.

FIG. 8 shows a further embodiment of a base body according to the invention or of an object carrier according to the invention, respectively.

### DESCRIPTION

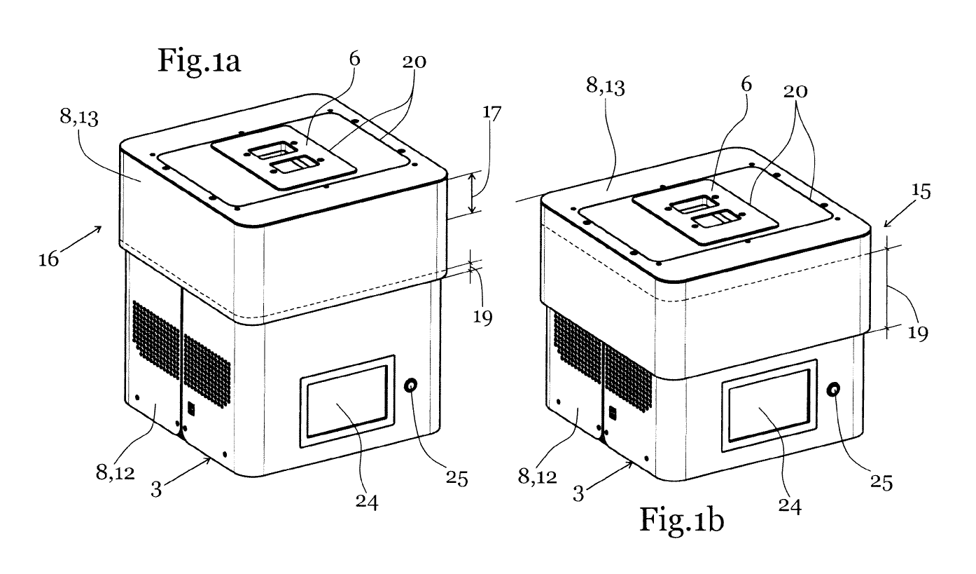

FIGS. 1a, 1b and 1c show an embodiment of a system according to the invention comprising a main body 3 and a housing 8. The housing 8 is embodied in a plurality of parts. The housing 8 in particular comprises a first housing part 12 and a second housing part 13. As shown in this embodiment, provision can be made on the housing 8 and/or on the main body 3 for a display device 24 and/or for one or a plurality of operating elements 25. The display device 24 can be embodied as common display device, such as LCD display device, for example. If applicable, the display device is also a touch-sensitive display device and in particular a touch screen. However, in the case of an embodiment of the display device 24 as touch screen, the display device 24 itself is also an operating element 25. If applicable, however, provision is also made for an independent operating element 25. Such operating elements can make it possible to influence the controller of the system according to the invention, for example.

The main body 3 is preferably arranged so as to be stationary and can be placed onto a solid ground, for example, such as a table or a floor, for example. The main body 3 is at least partially, preferably completely surrounded by a housing 8. If applicable, provision is made in the housing 8 for openings, for example for the entry and discharge of cooling air or for pug connections. If applicable, the main body 3 is surrounded by a first housing part 12 or is connected to a first housing part 12 in one piece. Provision is furthermore made for a second housing part 13. This second housing part 13 is preferably embodied in such a way that, together with the first housing part 12, it completely surrounds the housing 8 and thus forms a substantially closed housing 8. The second housing part 13 preferably has one or a plurality of housing openings 20. The housing openings 20 are or the housing opening 20 is preferably embodied so as to be capable of being closed. The housing opening 20 is closed by means of a cover, for example, which completes the form of the housing 8 or the housing 8.

Provision is furthermore made for a base body 6. This base body 6 in particular serves the attachment or construction of the object 1, which is to be formed. The base body 6 can preferably be accessed, taken out or removed from outside the housing 8. In particular, the base body 6 extends into the housing from the outside. As in the embodiment at hand, provision can be made thereby for housing openings 20 of different sizes. The base body 6 is preferably held by a holding device 7, which is not visible in this illustration. According to a preferred embodiment, the holding device 7 is embodied so as to be capable of being moved via a moving device 10—also not visible—relative to the main body 3. The system according to the invention can be brought from a first position 15, as shown in FIG. 1b, for example, into a second position 16, as shown in FIG. 1a, for example, via the moving device 10. Between the first position 15 and the second position 16, the holding device 7 covers a distance 17. The distance 17 covered in response to the formation of an object corresponds approximately to the height of the formed object.

If applicable or according to the embodiment at hand, the second housing part 13 is coupled or connected to the holding device 7. In response to moving the holding device 7 via the moving device 10, the second housing part 13 is also moved. The housing 8 is thus embodied so as to be extendable or extendable in a telescopic manner. In the embodiment at hand, the housing 8 is embodied in a box-like manner. The first housing part 12 has slightly smaller outer dimensions than the inner dimensions of the second housing part 13. The second housing part 13 can thus be put or slid over parts of the first housing part 12 in a box-shaped manner. However, it is obviously also in line with the idea of the invention that the first housing part 12 has as slight oversize as compared to the second housing part 13.

In particular, the two housing parts 12, 13 overlap one another by a certain and preferably by a variable overlap distance 19. In all of the embodiments, the overlap distance 19 is in particular that distance, by which the two housing parts overlap, thus for example the distance between the lower edge of the second housing part 13 to the upper edge of the first housing part 12. The overlap distance runs in particular along the direction of movement of the relative movement of the two housing parts 12, 13. In the embodiment at hand, the overlap distance 19 of the first position 15 is larger than the overlap distance 19 of the second position 16. The two housing parts 12 and 13 overlap one another in both positions, so that the housing is embodied so as to be substantially closed at any point in time and/or in every operating position. The overlap distance 19 of the housing in the first position 15 is preferably larger than the covered distance 17 for forming the object.

It is an advantage of the housing parts, which are embodied so as to be extendible, that the system according to the invention can be retracted to a small pack size. In contrast to rigid housings, the overall size of the system according to the invention can thus be reduced. It is a further advantage of the embodiment according to the invention of the housing and of the holding device that the base body 6 can extend outwards or that the base body 6 can be accessed directly or can be removed from the outside. The object 1, which is to be formed and/or the base body 6 can thus extend outwards, regardless of the space inside the housing 8. Objects 1 can thus be formed, which would on principle not fit into the housing 8 because of their outer dimensions.

Base bodies 6, to which the object 1 is attached, can furthermore also be used. These base bodies 6 can also be embodied so as to largely be independent from the housing size, because the base body 6 can project outwards through the housing 8.

The moving device 10 is in particular equipped to carry out a translatory movement of the holding device 7 relative to the main body 3. For example, this translatory movement is a parallel shift of the holding device 7 relative to the main body 3. The direction of the movement is preferably substantially vertically or perpendicular, respectively, relative to the environment.

The two housing parts are preferably embodied in a box-shaped manner, wherein the second housing part 13 is embodied in a hood-shaped manner, if applicable, and is open to the bottom, so that the second housing part 13 can extend around the main body 3 and in particular around the first housing part 12. The second housing part 13 preferably has a circumferential closing edge, which runs substantially horizontally in the lower area, for example.

FIG. 1c shows a system according to the invention with the base body 6 being taken off. Provision is made below the housing opening 20 for a trough 9. In the operational position, a mass 2 is located in the trough 9. In the first position 15, at least a part of the base body 6 is immersed in the mass 2 or is only attached to the mass 2. By means of selective solidification of the mass 2 in the area of the base body 6, the object 1 can be attached to the base body 6. As in the embodiment at hand, the base body 6 can be embodied as a pure object carrier, which is not a part of the object or product to be formed. After the formation, the object 1 to be formed is taken off the base body 6, which is embodied as object carrier, in this case. If applicable, however, the base body 6 itself is an object 1, which is formed by means of the system according to the invention. If applicable, the base body 6 is a part of a product, wherein the object 1 is attached to the base body 6.

As can be seen in the embodiment at hand, the base body 6 can extend all the way to outside of the housing or all the way to the outside and the size and shape thereof is thus limited only slightly.

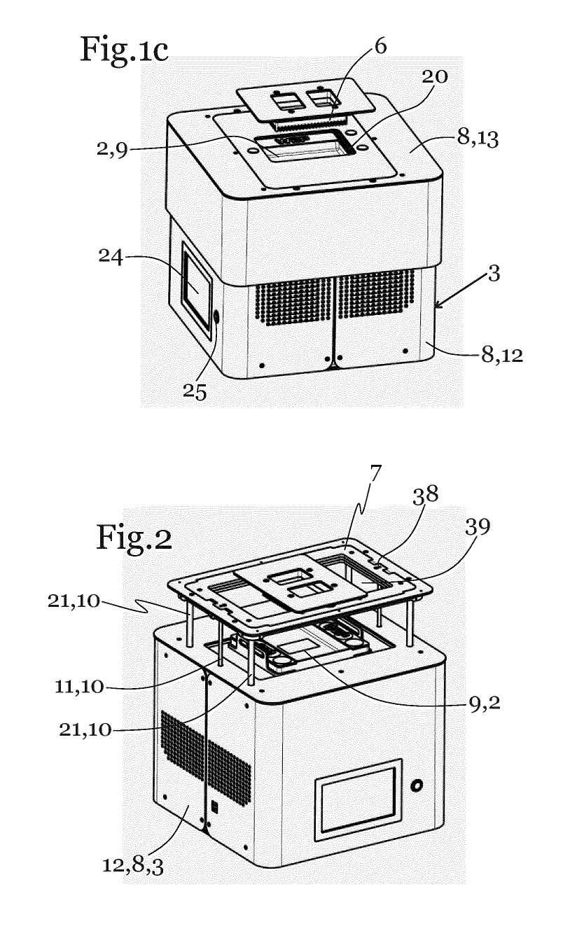

FIG. 2 shows an angular view of a system according to the invention, wherein parts of the housing 8 are hidden or taken off. In particular, the second housing part 13 is hidden or taken off. If applicable, the second housing part 13 is connected or coupled to the holding device so as to be capable of being removed, so that components of the system located on the inside can be accessed by simply removing the second housing part 13, for example by lifting it.

If applicable, the first housing part 12 surrounds or forms the main body 3 of the system. Provision is furthermore made for a holding device 7. The holding device 7 is connected or coupled to the main body 3 via a moving device 10. In the embodiment at hand, the moving device 10 comprises a plurality of elements, via which the movability of the holding device 7 relative to the main body 3 is made possible.

A trough 9 is arranged on the main body 3 or so as to be connected to the main body 3. In its operational position, a mass 2 or a plurality of masses 2 are located in the trough 9 in a preferable manner.

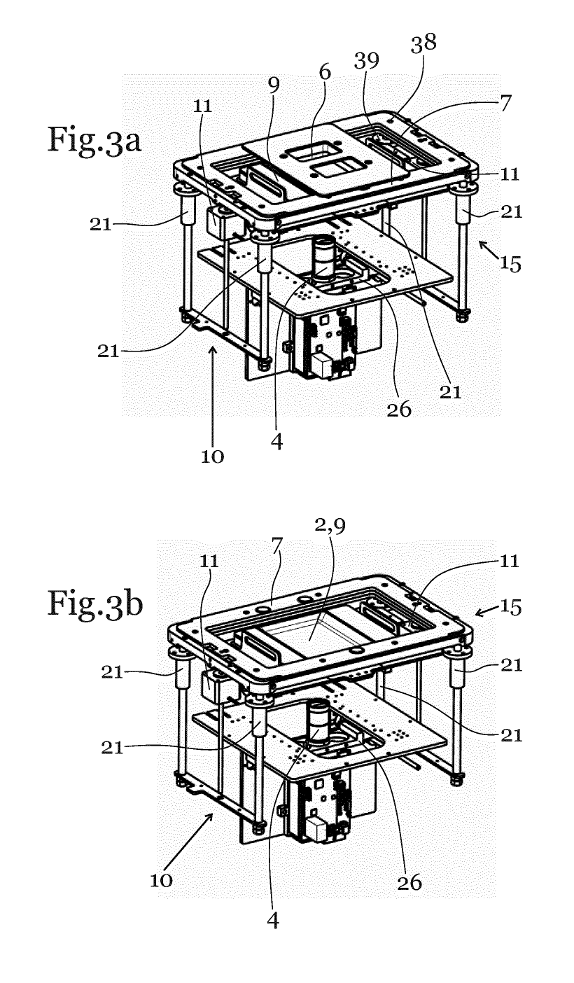

FIGS. 3a, 3b and 3c show a system according to the invention in different positions, wherein the main body and the housing are hidden in the views of FIGS. 3a 3b, 3c. Further components, such as the power supply or the display device 24, for example, are also hidden.

FIGS. 3a, 3b, 3c show parts of the system according to the invention, in particular a holding device 7 in a first position 15 or in a second position 16, respectively, a radiation source 4, a moving device 10, drives 11, guide devices 21, a trough 9 comprising a mass 2, which is provided in the trough 9.

FIG. 3a shows the components in a first position 15, wherein the base body 6 is held by the holding device 7. As in the preceding embodiments, the base body 6 extends outwards, if applicable. In the embodiment at hand, the base body 6 is in particular embodied as object carrier. It has a handle, which points outwards, in a preferred manner. The object carrier can be taken off easily to the outside and can be taken off by means of this handle. In all of the embodiments, however, provision can also be made, if applicable, for a base body 6, which is a part of the object to be formed or a part of the product to be formed, instead of a base body 6, which is embodied as object carrier.

To bring the device from the first position 15 into the second position 16, provision is made for a drive 10. In this embodiment, provision is in particular made for two drives 10, which engage with the main body on the one hand and with the holding device 7 on the other hand, preferably spaced apart from one another. The drives 11 are in particular embodied as linear drives. By activating the drive or the drives 11, a relative movement of the holding device 7 relative to the main body is effected. In the embodiment at hand, the two drives 11 are arranged on opposite sides of the holding device 7 or of the main body 3, respectively.

Furthermore, the moving device 10 preferably comprises guide devices 21. These guide devices 21 comprise elongated guide elements, for example, which are guided through sockets, for example.

In the embodiment at hand, provision is made for a plurality of guide devices 21, which are spaced apart from one another. The distance from one another in particular has the result that a canting of the guide devices is avoided. If applicable, provision is made for the guide devices 21 are provided on opposite sides of the holding device 7 or of the main body 3, respectively. Provision is preferably made for three or four guide devices on the outer side edges or corners, respectively, of the holding device 7 or of the main body 3, respectively.

If applicable, provision is made in all embodiments for the holding device 7 to comprise a component 38, which is embodied in a frame-shaped manner, in particular a frame 38, which has an exemption 39, through which the trough 9 can be guided preferably horizontally and can be connected to the main body 3. A trough 9, which is filled with a liquid mass 2, can thus be introduced into the housing from the top, without the liquid being spilled thereby. If applicable, provision is made for the second housing part 13 to be held and moved, if applicable, by the component, which is embodied in a frame-shaped manner, and for the base body 6 to be held by the holding device 7 and/or the housing 8. If applicable, provision is made in all embodiments for the moving device 10 to engage with the frame-shaped component 38.

The device or the holding device 7, respectively, can be brought from a first position 15 into a second position 16 by means of the moving device 10. The holding device 7 is thereby shifted relative to the main body 3. The holding device 7 is in particular shifted by a covered distance 17 relative to the main body. The holding device 7 is preferably guided in parallel relative to the main body 3. The second housing part is thereby preferably also shifted by the same distance 17.

The embodiment according to FIG. 3 furthermore comprises a radiation source 4. This radiation source 4 is embodied as projector, for example. The radiation source 4 is preferably arranged so as to be capable of being displaced or is arranged so as to be capable of being moved, respectively, via one or a plurality of radiation source drives 26. The movement of the radiation source takes place in particular in a plane, which is parallel to the layer, which is to be formed, of an object 1. In a preferred manner, this is a plane, which runs horizontally. If applicable, provision is made for two radiation source drives, via which a radiation source is capable of being moved in two directions. These two directions are in particular located normally to one another, so that an x-y shift of the radiation source 4 in a plane, which is parallel to the object layer, is possible. In this embodiment, the main direction of the radiation of the radiation source 4, which hits the mass, preferably runs perpendicularly, in particular perpendicularly upwards from the radiation source in the direction of the mass 2. If applicable, the main direction of the radiation, which hits the mass, is deflected via an optical element, such as, for example, via a mirror. In this embodiment, the main direction of the radiation of the radiation source 4, which hits the mass, runs partially perpendicularly and the main direction of the radiation in particular hits the mass perpendicularly and preferably from the bottom.

The trough 9 is preferably connected or can be connected to the main body 1. By activating the drive 11, the holding device 7 is also moved relative to the trough 9.

FIG. 3b shows the same device as FIG. 3a, wherein the base body 8 is hidden or removed in FIG. 3b. The illustrated parts of the device according to the invention are located in the first position 15.

FIG. 3c shows parts of the device according to the invention in the second position 16. In this position, the holding device 7 is shifted relative to the main body 3 and relative to the first position 15 by a covered distance 17. This shifting takes place via the activation of the drive or the drives 11. The shifting of the holding device 7 also results in a shifting of the holding device relative to the trough 9. This shifting can take place gradually. The holding device can in particular be stopped in a number N between of intermediate positions, which are located between the first and the second position. A layer by layer construction of an object 1 can take place by gradually moving the holding device relative to the trough and/or relative to the main body and by simultaneous or synchronized activation of the radiation source 4. The radiation source preferably emits the radiation in the intermediate positions, in which the holding device is in rest position(s). The radiation 5, as it can be provided in all positions and embodiments, is furthermore also illustrated schematically. In all embodiments, the bottom 14 of the trough can also be arranged at this location.

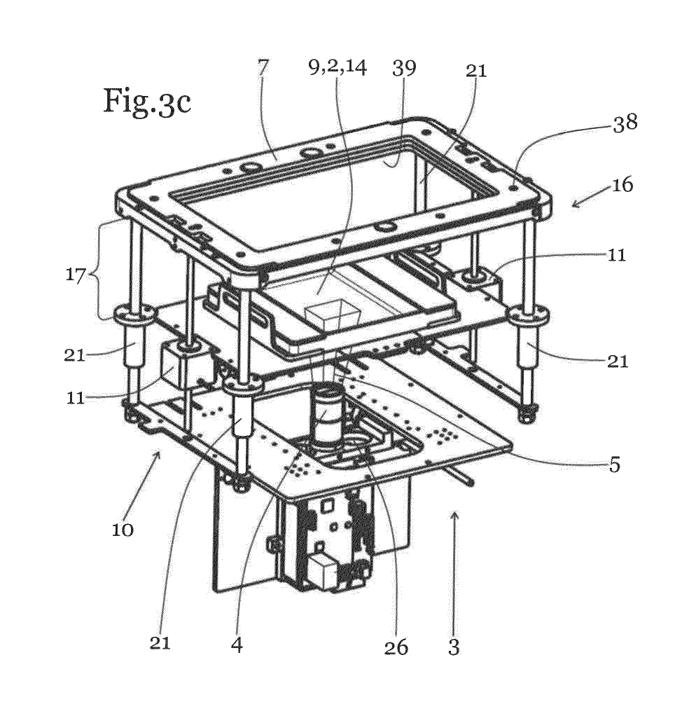

FIGS. 4a, 4b and 4c show different embodiment options of the trough 9. FIG. 4a shows a trough 9 according to the invention, which is substantially embodied as a continuous trough. Provision is made in the edge area of the trough for connecting elements 27. The trough preferably furthermore comprises one or a plurality of handles 28. The connecting elements 27 of the trough 9 are in particular suitable and equipped to be connected to the system according to the invention or to the main body, respectively. The connecting elements 27 can be parts of the trough, for example, and can be recesses in the edge area of the trough, if applicable. If applicable, the connecting elements 27 comprise further elements, such as rigid plates or additional bodies, for example, which are in particular suitable to improve the stability or the manageability of the trough.

FIG. 4b shows a trough 9, in the case of which provision is made for a separating web 22. In the embodiment at hand, two partial troughs 23 are formed by means of the separating web 22. The two partial troughs 23 are separated from one another by the separating web 22. Provision is in particular made for a lateral, horizontal separation, so that two different masses 2 do not mix automatically and/or are separated from one another, wherein provision is made for one mass 2 in the first partial trough and for one further mass 2 in the second partial trough.

FIG. 4c shows a further embodiment of a trough 9, in the case of which provision is made for a plurality of separating webs 22. In this embodiment, in particular eight partial troughs 23 are formed by means of the separating webs 22. It goes without saying that any number of partial troughs 23 can be formed in all embodiments of the invention by suitable selecting the separating webs 22.

If applicable, the separating webs 22 of all embodiments are embodied as separating webs, which are inserted subsequently. They can be connected to the trough 9 by means of a substance-to-substance bond or in a positive manner, for example, in order to form partial troughs 23. If applicable, the separating webs 22 are connected to the trough 9 in one piece and are in particular embodied as a part of the trough.

If applicable, the trough 9 is at least partially made of an elastic material. In all embodiments, the separating webs 22 can also be made of an elastic material. A possible adhesive, by means of which separating webs 22 can be connected to the trough 1, preferably has a certain elasticity, so as to ensure the elasticity of the entire trough and in particular of the adhesive areas.

FIG. 4d shows a possible embodiment of the base body 6. This base body is in particular suitable to cooperate with the trough 9 from FIG. 4c. On principle, however, this base body 6 is also suitable to be used with the troughs 9 of FIGS. 4a and 4b.

The base body 6 illustrated in FIG. 4d has a plurality of appendages 29. The appendages 29 preferably extend to the outside parallel to one another from a base plate of the base body 6. In operational position, the base body is held by the holding device or is attached to the holding device. In this operational position, the appendages 29 project in the direction of the trough and in particular into or to the mass 2. The appendages 29 are preferably released laterally. If applicable, this has the advantage that, when the appendages 29 of the base body 6 are immersed, less mass 2 needs to be displaced than when a holohedrally embodied body is immersed into the mass 2. The attachment of the object 1 to the base body 6 is improved and facilitated through this. In all embodiments, the base body can also be embodied so as to be smooth or wedge-shaped, if applicable.

If applicable, the appendages 29 are arranged in groups. These groups of appendages 29 are preferably arranged spaced apart from one another and in particular laterally spaced apart. The groups are preferably spaced apart from one another in such a way that the separating webs 22 of the trough 9 can protrude into the free space between the groups. In the embodiment of FIG. 4d, in combination with the trough from FIG. 4c, eight different objects of eight different masses, if applicable, can thus be formed in one procedure. In the case of a combination of the base body 6 with the trough from FIG. 4b, a plurality of objects can be made from two different masses, for example.

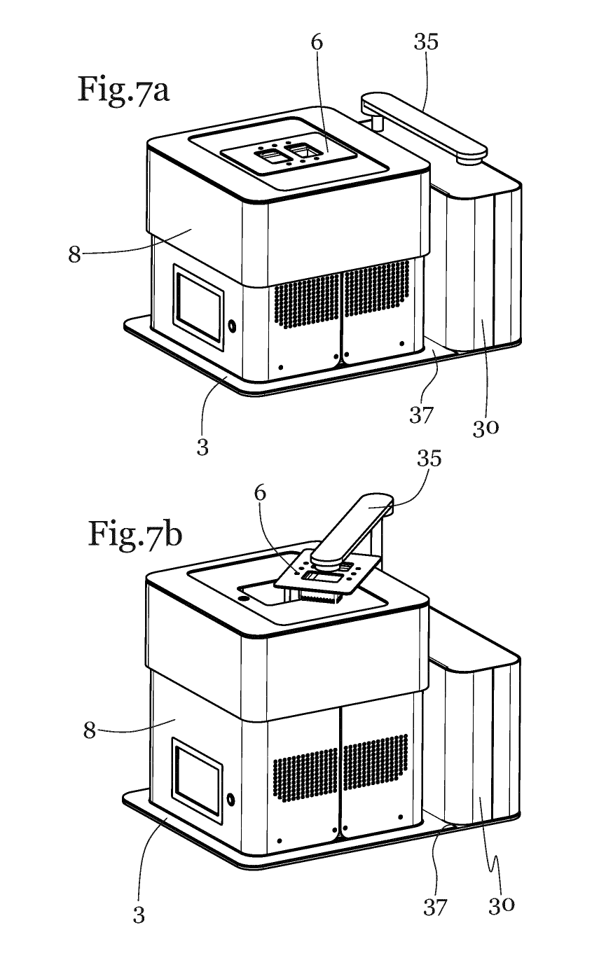

If applicable, provision is made for a handling device 30 in particular according to FIG. 7, which provides for a displacement of the base body 6 relative to the trough 9 or relative to the main body 3. This displacement can take place in all spatial directions, depending on the design of the handling device. A group of appendages 29 can thus come into contact with different masses in sequence and can thus form one or a plurality of objects 1 of a plurality of masses 2, for example in response to a rotation of the base body by 180° about a substantially vertical axis.

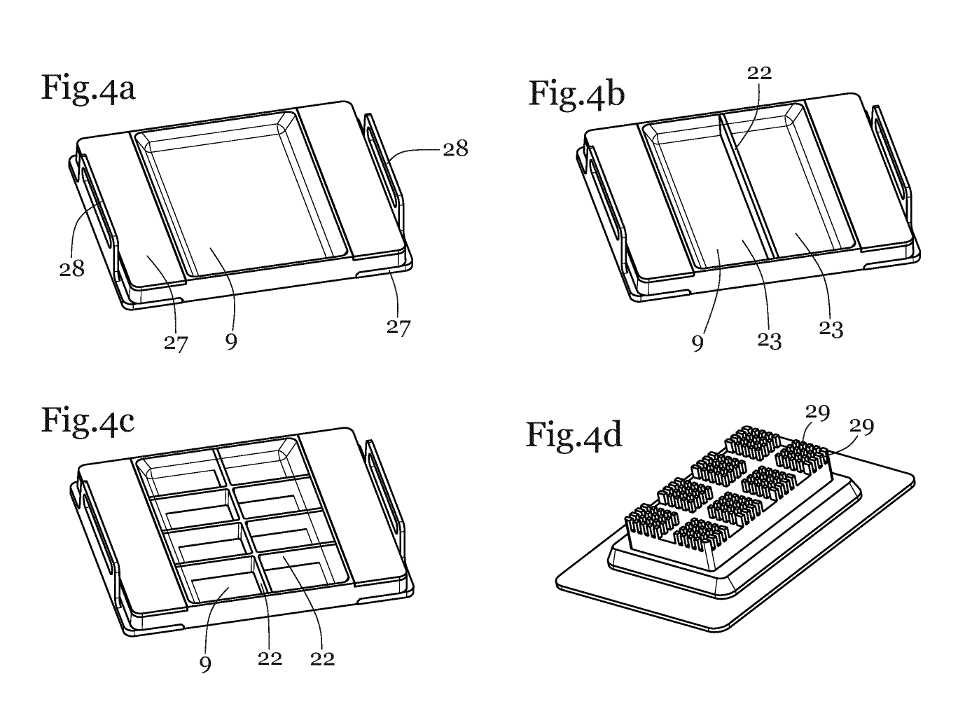

FIG. 5 shows a detailed illustration of a possible embodiment of a trough 9. The trough 9 comprises a plurality of separating webs 22, which are connected to the main body of the trough 9 in one piece. Provision is made for partial troughs 23, in particular for eight partial troughs 23 in this embodiment, by means of the separating webs 22. If applicable, different masses 2 can be arranged in the different partial troughs 23, so as to be able to form objects 1 of different masses 2.

The embodiment at hand of the trough 9 according to FIG. 5 comprises connecting elements 27. The connecting elements 27 can be embodied in a plurality of parts for example. The connecting elements 27 preferably comprise exemptions 31. These exemptions 31 are in particular equipped and/or suitable to be connected to elements of the main body. The connection of the trough relative to the main body of the device takes place via the connecting elements 27. If applicable, the connecting elements, which are arranged on the main body, and which engage with the connecting elements 27 of the trough, are arranged so as to be capable of being moved, so that, if applicable, a tensioning of the trough, a bending of the trough or a relaxing of the trough can take place via movement of the connecting elements of the main body.

If applicable, the connecting elements 27 have magnetic or magnetizable elements 32. These elements 32 are in particular equipped to provide for a simple connection of the trough to the main body. The trough can thus be connected to the main body by simple attachment from the top. The trough can then be held on the main body via magnetic forces.

The exemptions 31 preferably run vertically from the bottom into the side areas of the trough. If applicable, however, the exemptions 31 also have undercuts, which run substantially horizontally into the trough material, for example. A further locking of the trough relative to the main body can thus take place, for example via hook elements.

The trough 9 is to in particular be protected against being taken off to the top. This preferably takes place via magnetic forces, undercuts and/or hook elements, in particular via positive elements or, if applicable, via frictionally engaged connections.

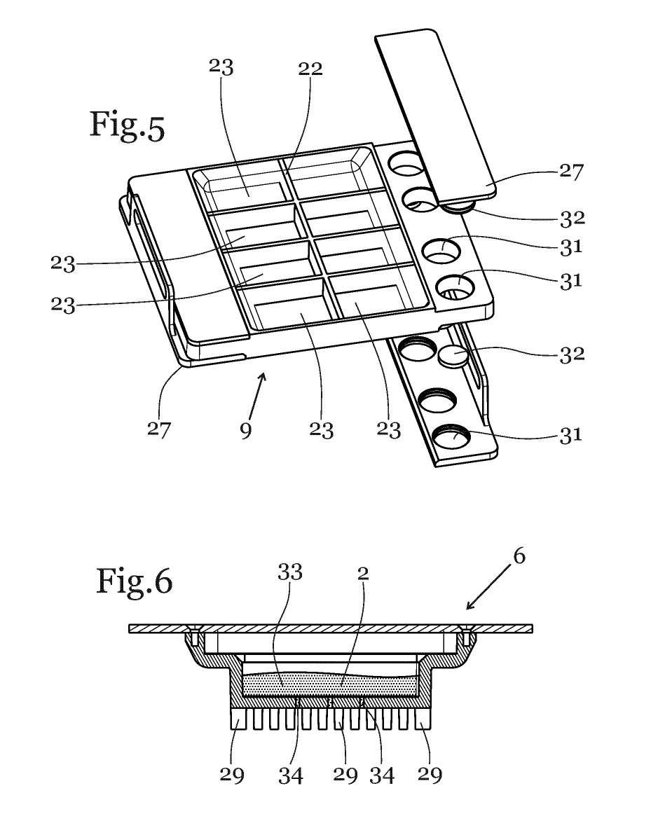

FIG. 6 shows a further possible embodiment of the base body 6. The base body 6, in turn, comprises appendages 29. The appendages 29 are preferably directed downwards and particularly preferably in the direction of the mass 2 of the trough 9. In this embodiment, the base body 6 comprises a reservoir 33 for receiving a mass 2 or a substance for adding into the mass 2. If applicable, provision can also be made for a plurality of reservoirs, which are separated from one another. If applicable, provision can be made in all embodiments for a base body comprising a reservoir. If applicable, the reservoir 33 is connected via supply openings 34 to that area of the base body 6, in which the appendages 29 are arranged or in which the object 1 is formed. Via this additional reservoir 33 and in particular via the supply openings 34, a mass 2 or a substance can be guided from the rear side of the base body into that area of the base body 6, in which the object is to be constructed or attached. It can be attained through this, for example, that the spaces between the appendages 29 are filled with the mass 2 or are at least partially filled. The base body 6 or the appendages 29, respectively, do not need to be immersed into the mass subsequently, but it is sufficient for them to be attached to the mass. The displacement of the mass 2 in the trough 9 can be reduced further through this.

If applicable, the reservoir is embodied in such a way that the base body is embodied so as to be hollow on its upper side or has a hollow space. If applicable, provision can be made in the reservoir for an additive for the mass 2. This additive can be or include a dye, for example, in particular color pigments, one or a plurality of fillers and/or one or a plurality of additives. The consistency or the composition of the mass, in particular of the mass located in the trough, can thus be changed during the formation of the object. In all of the embodiments, provision can be made for this purpose in the supply lines 34 or in the supply line 34 for a valve, which can be controlled or regulated. The supply of the substance of mass located in the reservoir can be controlled or regulated via controlling or regulating the valve. For example, this substance can be introduced into the mass in a drop-shaped manner. If applicable, provision is made for a spray head, so that the substance, which is provided in the reservoir, can be applied to the mass or to the object in a dispersed manner.

If applicable, provision can be made in the trough for a movable element, which removes or pushes aside the mass located in the trough. In a further step, a further, second mass, which differs from the first mass, if applicable, can be supplied via the supply opening or the supply openings. If applicable, the first mass is pushed into an area of the trough, in which a construction of an object does not take place. An object, which is made of different masses, can thus be produced in a single trough or in a single partial trough. If applicable, provision is made for a plurality of reservoirs, which contain a plurality of different additives or masses. For example, different dyes can be arranged in a plurality of reservoirs. If applicable, every reservoir is connected to the interior and in particular to the trough via a supply opening, so that the substance can be introduced into the trough. If applicable, different reservoirs comprising different supply openings are provided for the different partial troughs. Provision is made, if applicable, in all embodiments for at least one supply opening for each partial trough.

If applicable, provision is made for a locking element for each supply opening or for each partial trough, so that the individual partial troughs can be loaded independently from one another with one or a plurality of substances from the reservoir. If applicable, these locking elements are embodied as valve system. This valve system can be controlled via software, for example. This embodiment can in particular be combined with all further embodiments.

FIG. 7, in particular FIG. 7a and FIG. 7b show a further embodiment of a system according to the invention. In this embodiment, said system comprises a handling device 30. The handling device 30 is in particular equipped and/or suitable to move the base body 6 in a desired manner via a suitable controller. For example, the handing device 30 can be embodied as changing device. A handling device 30 embodied as changing device is in particular suitable to take a base body 6 off the holding device and, if applicable, to place it down at a different location. In this embodiment, the handling device 30 is furthermore suitable, if applicable, to take a new, second base body 6 off a storage area or a magazine, and to connect or couple it to the holding device. A plurality of objects 1 can thus be formed on a plurality of base bodies in an automated manner.

If applicable, the handling device 30 is equipped and/or suitable to attach a (single) base body 6 onto or to the device according to the invention in different positions, or to connect the base body to the device in different positions. The base body can be rotated and/or displaced, for example.

The handling device can be fixedly or rigidly connected to the main body 3 of the system, respectively. If applicable, the handling device 30 is an independent module, which can be placed or is placed next to the main body 3 or next to the housing 8, respectively, of the device. If applicable, provision is made for centering means 37, so that the position of the handling device 30 is fixed or can be fixed relative to the base body 6. These centering means can be webs or recesses, for example, into which the handling device 30 or the main body 3 or the housing 8, respectively, can be inserted with a certain fit. If applicable, the base body 6 and the handling device 30 have a common base plate, via which the handling device 30 is centered relative to the base body 6.

FIG. 7 shows a device according to the invention in two different positions. The handling device comprises an arm 35, which is arranged in a movable manner. The arm 35 is in particular arranged so as to be movable relative to the main body 3, so that a base body 6 can be removed or moved.

The controller or the regulation, respectively, of the handling device 30 is preferably connected to the controller or regulation, respectively, of the device for forming the object 1, can be connected or is embodied as a single controller or regulation, respectively.

If applicable, the connection of the controller is established automatically by bringing together the main body 3 and the handling device 30. If applicable, the handling device 30 is embodied as changing system. If applicable, the latter can be a part of the system according to the invention and/or can be combined with the system. Because of the accessibility of the base body from the outside, it is possible for the base body to be removed in an automate manner together with the formed object, and for a new base body to be supplied, if applicable.

If applicable, a mass 2 can furthermore be supplied or refilled in all embodiments by means of the handling device. Provision can be made for this purpose for a mass reservoir comprising a metering device, which can be activated by a handling device, wherein the metering device comprises a valve and/or a pump, if applicable. If applicable, an additional or new mass is supplied by the handling device via a reservoir in the base body.

If applicable, the system comprises a magazine for receiving or holding a plurality of base bodies. If applicable, this magazine can be integrated in the changeover module or in the handling device, respectively.

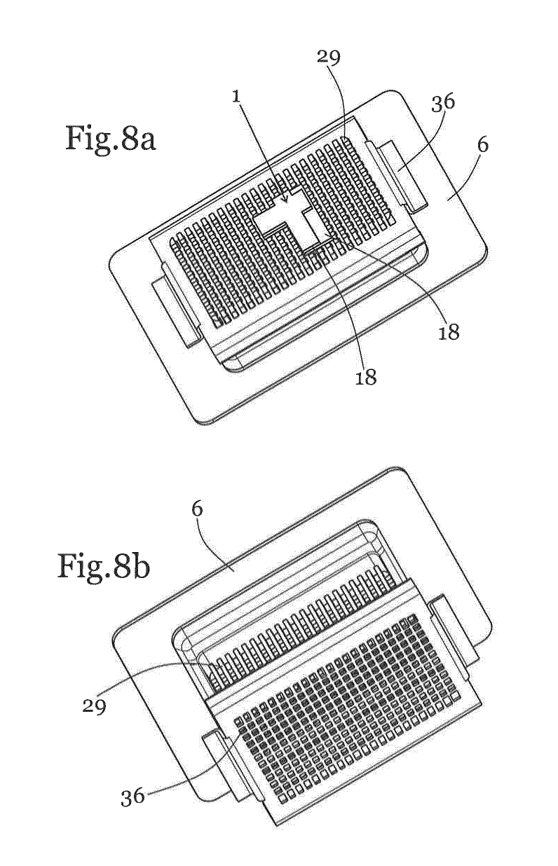

FIG. 8, in particular FIG. 8a and FIG. 8b show or shows, respectively, a further embodiment of a base body 6 according to the invention. The embodiment is in particular illustrated in two different positions. The base body 6 comprises a plurality of appendages 29. The appendages are suitable and/or equipped to attach an object 1 in particular of a plurality of layers 18 or to construct it thereon. To facilitate a removal of the object 1 from the appendages 29 or from the base body 6, respectively, provision is made for a separating element 36. Prior to the construction of the object, this separating element 36 is preferably arranged in the space between the appendages 29. If the object 1 is now attached to the appendages and in particular to the protruding ends of the appendages 29, the separating element 36 is located between the object 1 and a base plate of the base body 6. To separate the object 1 form the base body 6, the separating element 36 can subsequently be moved in the direction of extension of the appendages 29. A force for releasing the adhesion along the connecting surface between object 1 and base body 6 can thus be exerted by means of the separating element 36 between the object 1 and the base body 6. This has advantages, because a destruction-free removal of the object 1 from the base body 6 is facilitated. In the embodiment of FIG. 8 at hand, the separating element 36 is embodied as grid-shaped body. This grid-shaped body comprises a plate-shaped basic structure, in which grid-shaped exemptions are arranged. The exemptions are in particular arranged as passage openings, which permeate the plate-shaped basic structure. The exemptions of the separating element 36 in particular have the same shape or arrangement, respectively, as the appendages 29 of the base body 6, which is used together with the separating element 36. The appendages 26 can thus be guided through the exemptions in the separating element 36.

On principle, however, any setup of a separating element 36 is suitable to improve the device according to the invention, in the case of which an arrangement of the separating element 36 is made possible between the base body 6 and the object to be constructed. Such a separating element can be provided in all embodiments.

If applicable, the separating element is integrated in the base body or is attached to the base body as perforated grid. The separating element can thereby be connected to the base body by means of magnets or the like during the formation of the object. After the printing process, a flat print can be applied from the rear side of the object by pulling off the separating element or the perforated grid, respectively. The object or the objects can thus be removed from the base body.

In particular in combination with a handling device, a separation of the object from the base body can thus take place in an automated manner. For example, an object could thus be separated from the base body in an automated manner and could be stored in a container, if applicable. This can take place by automatically pulling the separating element. If applicable, the handling device itself has a separating element, which, due to its geometry, is suitable to engage with openings of the base body so as to release the parts by mean of surface pressure.

The system according to the invention preferably comprises a radiation source, which can be embodied as follows, for example: The radiation source can in particular be embodied as projector and/or beamer. If applicable, the used radiation source is a DLP (Digital Light Processing) beamer. The latter preferably comprises a DMD=Digital Mirror Device—thus an array of many small individual mirrors, which can be controlled individually and thus reflect the incident light in the direction of the lens (corresponds to a light pixel) or to an absorber (corresponds to a black pixel)—on principle, every mirror represents a pixel. If applicable, the radiation source has approximately 600 to 6000×300 to 3000 pixels, preferably 1280×800 pixels. If applicable, two lenses, which create a resolution of between 50 μm and 65 μm, for example, are used. At 50 μm, the individual field thus has a size of 64×40 mm, at 65 μm, it has a size of 83.2×52 mm. By stringing together three fields, a total construction field of 64×120 mm (50 μm) or 83.2×156 mm (65 μm) results, respectively. When using two radiation sources, in particular two radiation sources according to the above-specified embodiment of the radiation source, the field also has a size of 128×120 mm at 50 μm, if applicable. The LED used in the case of the embodiment, which is specified in an exemplary manner, has an output of between 1 W and 20 W, for example.

An exemplary mass can comprise or be a monomer mass of a monomer or a plurality of different monomers, for example. If applicable, the mass also comprises inorganic particles, metallic particles, ceramic particles, dyes, additives, fillers and/or dyes. Exemplary masses can be acrylates or methacrylates, for example. The mass can preferably be solidified into a polymer by means of radiation. All of the masses, which can be used, preferably have in common that the in particular liquid or pasty starting material of the mass, which is not dimensionally stable, is enriched with a photo initiator. This photo initiator converts the light, which hits it, or the radiation of the radiation source, which hits it, chemically, whereby the polymerization and thus the solidification takes place or is excited.

If applicable, the radiation source can be displaced in XY-direction, preferably horizontally, below the trough. If applicable, other semiconductor-based radiation or light sources can also be used instead of LED in all embodiments. If applicable, laser diodes can be used in the radiation sources in all embodiments. They can radiate in a pulsed or continuous manner, for example. The pulse lengths can be very short, e.g. in the picosecond range or in the femtosecond range. If applicable the wavelengths of the emitted radiation can range from the infrared range all the way to the ultraviolet range in all embodiments, in particular comprise or be a narrow frequency spectrum, such as, for example, only UV radiation or IR radiation or a broad frequency spectrum, all the way to actinic radiation. If applicable, a plurality of lenses comprising a firm resolution can be used in all embodiments for the image projection. If applicable, a variable lens, in the case of which the projection surface is adjusted continuously or in stages, can also be used. If applicable, one or a plurality of DMDs or directly emitting display resolutions, such as, e.g. LED or OLED displays, can also be used for this purpose in all embodiments.

The system according to the invention preferably comprises a plurality of components. These components can be the trough 9, the housing 8, the base body 6, the moving device 10, the display device 24, the radiation source 4, the radiation source drive 26, the handling device 30, and/or the object 1, for example. Together, a plurality of these components causes a synergetic effect and in particular form a system according to the invention.

According to a preferred embodiment, all of the mentioned components are provided in the system according to the invention. The individual components can be embodied in different embodiments. For example, provision can be made for one or a plurality of radiation sources. For example, the trough can be a plurality of partial troughs or a single trough. For example, the base body can be an independent body, such as in particular an object carrier. According to a modified embodiment, the base body can be an object, which is produced to or by the system.

According to a non-illustrated embodiment, the object 1 is a part of a die or is a die. In particular, an object, which has a die surface, which is preferably provided with a relief-like structure, is identified as die. By wetting the die surface with ink and printing on a substrate, the relief-like form can thus be printed onto a substrate. According to this use of the system according to the invention, the die surface and in particular the die plate, which supports the die surface, can be formed by selective section by section solidification of a mass, which is not dimensionally stable.

If applicable, the die surface is formed by means of the constructed object. If applicable, the base body is a part of the die and thus a part of the finished product. For example, a die handle as base body can be connected to the holding device or can be held by the holding device. The die surface and, if applicable, the die plate is subsequently constructed or formed, respectively, by means of the system according to the invention. The base body, which is embodied as die handle, can thereby be placed against or can be attached to the housing or the holding device of the system according to the invention, respectively, from the outside and can extend in particular to the outside. After the die surface has been completed, the die handle, which corresponds to the base body, can simply be taken off to the outside. In the case of this embodiment, the base body is a part of the finished product, in particular a part of the finished die. The base body or the base body, which is embodied as stamp handle, respectively, is preferably held by the holding device.

If applicable, the die handle is also capable of being or can be constructed by means of the system according to the invention. For this purpose, provision can be made, for example, for a first mass, which has a substantially rigid or hard consistency in response to solidification. A die handle can be constructed in layers from this first mass. In a next step, the formed die handle can be immersed into a second mass or can be attached to a second mass. After solidification, this second mass has a dimensionally stale, yet elastic, for example rubber-like consistency, as it is known from die surfaces. By means of this two-layered formation of a single object, a die can be made of different materials by means of the system according to the invention, substantially in one process.

If applicable, the handling device is equipped to carry out a change of the masses, so as to in particular move the base body from the one mass to the other mass.

If applicable, a base body, which is embodied in a plate-shaped manner, is provided with the die surface by means of the system according to the invention. This plate-shaped body can subsequently be connected to a die handle.

### LIST OF REFERENCE NUMERALS

1 object
2 mass
3 main body
4 radiation source
5 radiation
6 base body
7 holding device
8 housing
9 trough
10 moving device
11 drive
12 first housing part
13 second housing part
14 bottom of the trough
15 first position
16 second position
17 covered distance
18 connected layers
19 overlap distance
20 housing opening
21 guide devices
22 separating webs
23 partial troughs
24 display device
25 operating element
26 radiation source drive
27 connecting element of the trough
28 handle of the trough
29 appendage of the base body
30 handling device
31 exemption (connecting element of the trough)
32 magnetic elements
33 reservoir
34 supply openings
35 arm of the handling device
36 separating element
37 centering means
38 frame/frame-shaped component
39 exemption of the frame

1-38. (canceled)

39. A system for forming one or more dimensionally stable objects by selective section-by-section solidification of a dimensionally unstable mass to be hardened by light, the system comprising:
a main body arranged so as to be stationary;
a trough for connection to the main body, and which is configured to receive the mass;
one or more controllable light sources configured to emit radiation so as to solidify the mass;
a base body upon which the one or more dimensionally stable objects may be constructed;
a holding device configured to receive the base body;
a housing which surrounds at least the trough and the one or more controllable light sources;
a moving device, connected to the main body and the holding device, the moving device including a drive configured to move the holding device relative to the main body upon activation of the drive,
wherein the housing includes a first housing part connected to the main body, and a second housing part connected to the holding device such that relative movement between the first housing part and the second housing part is effected in response to relative movement of the holding device relative to the main body, and such that the main body, which is received in the holding device, extends outwardly and/or is configured to be accessed from the outside.

40. The system of claim 39, wherein:
the trough is open at a top end thereof; and
the trough has a light-permeable or transparent bottom which is permeable to radiation from the one or more light sources;
the base body is configured for immersion into the mass from the top, or is attached to the mass to form the one or more dimensionally stable objects;
the one or more light sources is arranged below the trough, and is directed through the bottom of the trough in a direction of the base body; and
the mass, which is provided between the bottom of the trough and the base body, is configured for solidification by selective section-by-section radiation via the one or more light sources.

41. The system of claim 39, wherein:
for formation of the one or more dimensionally stable objects, the holding device is configured for movement from a first position into a second position by activation of the moving device; and
a distance covered by the holding device corresponds approximately to a height of the one or more dimensionally stable objects constructed in response to the movement of the holding device.

42. The system claim 39, wherein the holding device is configured for movement from a first position into a second position, and a plurality of intermediate positions located between the first position and the second position, by activation of the moving device, such that the formed one or more dimensionally stable objects includes a plurality of layers which are connected to one another.

43. The system of claim 39, wherein:
the holding device and the second housing part are configured for movement from a first position into a second position, and a plurality of intermediate positions located between the first position and the second position, by activation of the moving device;
a distance covered by the holding device corresponds to a height of the formed one or more dimensionally stable objects; and
the first housing part and the second housing part overlap one another in the first position by an overlap distance that is greater than the distance covered by the holding device,
the first housing part and the second housing part overlap one another in the second position; and
the first housing part and the second housing part overlap one another overlap one another along a respective entire circumference.

44. The system of claim 39, wherein:
the second housing part, at an upper region thereof, has a closable housing opening arranged adjacent to the holding device such that the base body protrudes into the housing through the housing opening from a top region thereof; and
the base body is configured to close housing opening.

45. The system of claim 39, wherein the moving device comprises one or more guide devices, via which the movement of the holding device and the second housing part is guided in parallel relative to the main body.

46. The system of claim 39, wherein the trough comprises one or more separating webs which are laterally separated from one another.

47. The system of claim 39, wherein the one or more light sources are configured for movement in a plane parallel to a layer of the one or more dimensionally stable objects, and is configured for displacement such that a plurality of partial areas of the layer, which are arranged next to one another, are solidified and connected to one another in succession.

48. A system for forming one or a plurality of dimensionally stable objects by selective section-by-section solidification of a liquid to be hardened by light, the system comprising:
a main body arranged so as to be stationary;
a trough connected to the main body, and which is configured to receive the liquid;
one or more controllable light sources configured to emit radiation suitable to solidify the liquid;
a base body upon which the dimensionally stable objects are constructed, wherein the base body is a part of a die, and the formed dimensionally stable objects form at least a part of a die surface;
a holding device configured to receive the base body;
a housing which surrounds at least the trough and the light sources; and
a moving device connected to the main body and the holding device, the moving device including a drive configured to move the holding device relative to the main body.

49. The system of claim 48, wherein:
the die comprises a die handle and a die surface having relief-like elevations and depressions.

50. The system of claim 48, further comprising a handling device having one or more movable arms coupled to the base body so as to move the base body,
wherein the movable arms each have two driven variances relative to the main body, so as to rotate, relative to the holding device, the base body about a vertical axis, lift the base body off the holding device, lower the base body so as place the base body onto the holding device, and/or a pivot the base body so as to remove the base body from the holding device and the main body.

51. The system of claim 48, wherein the trough has a separating web to form at least two partial troughs, wherein:
the partial troughs are laterally separated from one another by the separating webs; and
the trough and the separating web is made of an elastic material that contains silicon or polydimethylsiloxane (PDMS).

52. The system of claim 51, further comprising connecting elements to connect the separating web to the trough, the connecting elements having exemptions configured to be engaged by elements the main body.

53. The system of claim 51, further comprising connecting elements to connect the separating web to the trough, the connecting element having magnetic or magnetizable elements equipped to provide for a magnetic connection of the trough to the main body.

54. The system of claim 52, wherein the elements of the main body are arranged so as to be movable so as to tension the trough, bend the trough, shift the trough, and/or relax the trough.

55. The system of claim 51, wherein the exemptions extend into side areas of the trough vertically from the bottom, the side areas being formed as laterally projecting lugs.

56. The system of claim 51, wherein the exemptions have undercuts which extend substantially horizontally into the trough so as to lock the trough relative to the main body via hook elements.

57. The system of claim 48, wherein the housing comprises:
a first housing part connected to the main body; and
a second housing part connected to the holding device so as to hold and move the base body.

58. The system of claim 57, wherein:
the holding device comprises a component having an exemption through which the trough is guided horizontally and is connected to the main body;
the second housing part is held and moved by the component; and
the base body is held by the holding device and/or the housing.
